(19) United States
(12) Patent Application Publication
(10) Pub. No.: US 2005/0136545 A1
(43) Pub. Date: Jun. 23, 2005

(54) Microfluidics devices and methods for performing based assays

(75) Inventors: Noa Schmid, Wuppenau (CH); Praveen Bansal, Quincy, MA (US); Gregory Kellogg, Cambridge, MA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Tecan Trading AG

(21) Appl. No.: 10/941,796

(22) Filed: Sep. 15, 2004

Related U.S. Application Data
(60) Provisional application No. 60/502,922, filed on Sep. 15, 2003.

(51) Int. Cl. G01N 35/00

(52) U.S. Cl. 436/45; 422/72; 436/63

(57) ABSTRACT

This invention provides methods and apparatus for performing microanalytic analyses and procedures, particularly miniaturized cell based assays. These methods are useful for performing a variety of cell-based assays, including drug candidate screening, life sciences research, and clinical and molecular diagnostics.

This application claims priority to U.S. Provisional Application Ser. No. 60/502,922, filed Sep. 15, 2003, the disclosure of which is explicitly incorporated by reference herein.

### BACKGROUND OF THE INVENTION

1. Field of the Invention

This invention relates to methods and apparatus for performing microanalytic analyses and procedures. In particular, the present invention provides devices and methods for the performance of miniaturized cell based assays. These assays may be performed for a variety of purposes, including but not limited to screening of drug candidate compounds, life sciences research, and clinical and molecular diagnostics.

2. Background of the Related Art

Recent developments in a variety of investigational and research fields have created a need for improved methods and apparatus for performing analytical, particularly bioanalytical assays at microscale (i.e., in volumes of less than 100 μL). In the field of pharmaceuticals, an increasing number of potential drug candidates require assessment of their biological function. As an example, the field of drug development there is a need to anticipate and characterize in vitro drug behavior in an animal. Such assays measure, inter alia, cell membrane permeability, cytotoxicity and drug metabolism.

As the first phase of drug discovery, compounds that represent potential drugs are screened against targets in a process known as High Throughput Screening (HTS) or ultra-High Throughput Screening (uHTS). An advantage of these screening methods is that they usually consist of simple solution phase biochemical assays that can be performed quickly and with small amounts of expensive compounds and reagents. However, a significant drawback to HTS is that the targets do not provide a functional assessment of compounds' effects on the complex biochemical pathways inherent in the normal and abnormal (mutant or disease-state) functioning of cells, tissues, organs, and organisms. As a result, compounds that have shown biochemical activity of interest in initial screens are usually put through cell-based screens, in which the affect of the compounds on cellular function is independently assayed.

Assays that measure the rate of drug metabolic clearance are crucial to drug discovery. In order to determine the suitability of a drug candidate, it is necessary to quantify how quickly that drug is cleared from the bloodstream. In an animal, the main mechanism of such clearance is enzymatic breakdown by enzymes contained in hepatocytes in the liver. It is of course impractical to measure metabolic clearance directly in humans, who comprise the largest drug target population. It is this necessary to use in vitro methods for determining bloodstream clearance in an animal due to the effects of such liver enzymes. This is conventionally done using a cell-based assay, where the drug or drugs of interest are mixed with a hepatocyte cell suspension and the concentration of the drug is measured over an appropriate time course. Assay and detection methods are typically adapted to the particular drug or drugs being studied.

There are a wide range of assays that may be performed using living cells. Assays that involve the use of living cells include gene expression, in which levels of transcription in response to a drug candidate are monitored; cell permeability assays, in which the ability of drugs to traverse membranes of cells is monitored; and functional assays designed to investigate both macroscopic effects, such as cell viability, as well as biochemical effects and products produced in and by the cells as a result of treatment with the drug lead compound.

These assays include cytotoxicity and cell proliferation to measure the viability of a population of cells, often in the presence of a putative therapeutic compound (drug candidate). A variety of methods have been developed for this purpose. These include the use of tetrazolium salts, in which mitochondria in living cells use dehydrogenases to reduce tetrazolium salts to colored formazan salts. Soluble or insoluble precipitates may be formed, depending on the nature of the tetrazolium salt used. A typical assay procedure is to culture the cells, add a solution of tetrazolium salt, phenazine methosulfate and DPBS, incubate, and determine absorbance at 490 nm. The absorbance measured is larger for viable cell populations that have metabolized the salt. Another such assay uses alamarBlue, which uses a fluorometric/colorimetric growth indicator that is reduced to a membrane-soluble, red, fluorescent form by the products of metabolic activity. A variety of other indicators are either taken up by living cells, dead cells, or both; for example, neutral red is taken up only by live cells, while trypan blue is excluded by live cells. Dyes that bind to or intercalate with DNA can be used to visualize or quantitate the number of live or dead cells, since DNA synthesis only occurs in living cells.

Cell permeability assays measure the transport of compounds across cells. The commonly-used example is the CaCo-2 cell line derived from human intestinal endothelial cells. When grown to confluency over a porous membrane, these cells form a “biologically active” filter: Transport of compound through the cell layer is accepted in the art to be correlated with absorption by the digestive system.

To achieve the goal of determining and predicting drug behavior using in cell-based, in vitro assays, a number of secondary features are desirable. First, it is advantageous to have a high degree of process automation, such as fluid transfer, cell plating and washing, and detection. It is also advantageous for the processes to be integrated so as to require a minimum of human intervention. Compound consumption (non-specific adsorption onto the materials comprising the assay apparatus) must be minimized, in order to prevent depletion of rare and/or expensive drugs or other reagents. This is most readily addressed through miniaturization of assays from their current scale of hundreds of microliters to ten microliters or less. A goal in the art is to provide automated, integrated and miniaturized apparatus for performing assays that are reliable and produce results consistent with the results produced by current, more laborious, expensive and time-consuming assays.

In addition to these advantages, miniaturization itself can confer performance advantages. At short length scales, diffusionally-limited mixing is rapid and can be exploited to create sensitive assays (Brody et al., 1996, Biophysical J. 71: 3430-3431). Because fluid flow in miniaturized pressure-driven systems is laminar, rather than turbulent, processes such as washing and fluid replacement are well-controlled. Miniaturized, most advantageously microfabricated systems also enable assays that rely on a large ratio of surface area to volume, such chromatographic assays generally and assays that require binding to a surface.

Miniaturization has led to the creation of 384-well and 1536-well microtiter plates for total reaction volumes of between 0.015 and 0.1 mL. However, a number of problems arise when miniaturizing standard plate technology, especially for use in conjunction with cells. First, because the total volumes are smaller and the plates are open to the environment, evaporation of fluid during the course of an assay can compromise results; this is especially problematic for cell based assays that may require incubation at elevated temperatures for up to several days. Another drawback of open plates is the existence of the meniscus of fluid in the well. Meniscuses of varying configurations (due, for example to imperfections in the plate or differences in contact angle and surface tension) can distort the optical signals used to interrogate the samples. As the strength of the optical signals decreases with decreasing assay volume, correction for background distortions becomes more difficult. Finally, optical scanning systems for high-density plates are often complex and expensive. Methods that minimize evaporation, provide a more uniform optical pathway, and provide simpler detection schemes are desirable.

Highly accurate pipetting technologies have been developed to deliver fluids in precisely metered quantities. Most of these fluid-delivery methods for low volumes (below approximately 0.5 μL) rely on expensive piezoelectric pipetting heads that are complex and difficult to combine or “gang” into large numbers of independent pipettors so that many wells may be addressed independently. As a result, fluid delivery is either completely or partially serial (i.e., a single micropipettor, or a small number of parallel delivery systems used repeatedly to address the entire plate). Serial pipetting defeats the aim of parallelism by increasing the amount of time required to address the plate. Methods that reduce the number and precision of fluid transfer steps are therefore needed.

Attempts to produce microfabricated devices for performing cell-based assays have been reported in the art. For example, International Patent Application WO98/028623, published 2 Jul. 1998 by several of the instant inventors, discloses a microfluidics platform for detecting particulates in a fluid, specifically including cells.

A microfabricated device explicitly for the performance of cell based assays in a centrifugal format has been disclosed in International Patent Application WO 99/55827, published November 1999. The operative principles of this device include the use of hydrophobic coatings along a radial channel punctuated by cell culturing chambers and optical cuvettes. However, this device cannot perform distinct assays on sub-populations of the cells cultured on the device. By providing only a single entry to a multiplicity of cell culturing chambers, all chambers are exposed to the same solutions, such as cell suspension, cell culture medium, test compounds and any reagents used for detection of the effects of these compounds. Furthermore, the format disclosed in WO 99/55827 relies on the manufactured surface of the microplatform to provide the support for cell attachment and proliferation, or the use of carrier beads. This may not be adequate for all cell types of interest. Finally, no provision is made for selectively trapping and incubating certain cells or cell types rather than others. In applications such as diagnostics, in which a variety of cells may be present in a biological sample such as blood, means for separating cells based on type or other features may be required.

Thus, there is a need in the art for improved micromanipulation apparatus and methods for performing cell based assays more rapidly and economically using less biological sample material. Relevant to this need in the art, some of the present inventors have developed a microsystem platform and a micromanipulation device to manipulate said platform by rotation, thereby utilizing the centripetal and centrifugal forces resulting from rotation of the platform to motivate fluid movement through microchannels embedded in the microplatform, as disclosed in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

### SUMMARY OF THE INVENTION

The invention disclosed herein relates to microfluidic devices for performing cell based assays for a variety of applications such as life sciences, diagnostics and drug screening. In particular, these devices have been developed particularly to carry out drug metabolism, cytotoxicity and cell membrane permeability assays in in vitro models for determining and characterizing drug behavior in an animal. Specifically, the invention provides microfluidic devices and methods of use thereof related to hepatocyte-mediated drug metabolism.

The devices comprise an entry port or other means for adding cellular suspensions, most preferably in vitro cell cultures, into the devices of the invention. Surfaces and supports comprising the devices have been fabricated, adapted or treated to prevent or inhibit cell attachment or growth to occur on device surfaces and supports. The devices of the invention are produced to facilitate distribution and mixing of solutions, preferably drug-containing solutions or suspensions, to cells introduced onto the devices of the invention, said solutions preferably carrying one or a plurality of drugs or other test compounds, or other reagents. Finally, the components of the devices of the invention are provided so that metabolites, break-down products, or other sequellae of drug metabolism in the cells can be detected, either directly or through reaction with appropriate reagents and either on the device platforms of the invention or after removal from recovery reservoirs or portions of reservoirs adapted for liquid recovery. Another preferred form of detection provided is the detection or visualization of said sequellae of drug metabolism directly on the device platform.

This invention provides microsystems platforms as disclosed in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein, adapted to facilitate distribution and mixing of solutions, preferably drug-containing solutions or suspensions, to cells introduced onto the devices of the invention, said solutions preferably carrying one or a plurality of drugs or other test compounds, or other reagents. Additional microfluidics components that facilitate the performance of cell based assays are also provided, as described in more detail herein.

The invention provides apparatus and methods for performing microscale processes on a microplatform, whereby fluid is moved on the platform in defined channels motivated by centripetal or centrifugal force arising from rotation of the platform. The first element of the apparatus of the invention is a microplatform that is a rotatable structure, most preferably a disk, the disk comprising loading (sample inlet) ports, fluidic microchannels, reaction reservoirs, reagent chambers and reservoirs, reagent distribution channels and manifolds, detection chambers and sample outlet ports, generically termed “microfluidic structures.” In certain embodiments, the platforms also comprise heating elements that make up a portion of the surface area of the platform for heating fluids contained therein to temperatures greater than ambient temperature. For example, said heating elements are positioned on the disk in sufficient proximity to microfluidics structures comprising cells, preferably hepatocytes, to permit cell viability without compromising the viability of said cells. Alternatively, the platforms are kept at an appropriate temperature by being placed in a controlled temperature environment or chamber, or in contact with a controlled-temperature element such as a heated water bath. Typically, in either of these alternative embodiments the temperature is a temperature adapted for cell growth, typically from about 25° C. to about 45° C., more preferably from about 30° C. to about 42° C., and most preferably at about 37° C. The disk is rotated at speeds from about 1-30,000 rpm for generating centripetal acceleration and centrifugal force that enables fluid movement through the microfluidic structures of the platform. The disks of the invention also preferably comprise air outlet ports and air displacement channels. The air outlet ports and in particular the air displacement ports provide a means for fluids to displace air, thus ensuring uninhibited movement of fluids on the disk. These air outlet ports also influence fluid movement in the microfluidics components of the platform by permitting fluid to flow locally in a direction (typically, towards the center of rotation) when motivated by fluid flow of greater force (typically, having greater volume) in a direction away from the center of rotation. Specific sites on the disk also preferably comprise elements that allow fluids to be analyzed, as well as detectors for each of these effectors.

The disks of this invention have several advantages over those that exist in the centrifugal analyzer art. Foremost is the fact that flow is laminar due to the small dimensions of the fluid channels; this allows for better control of processes such as mixing and washing. To this are added the already described advantages of miniaturization, as described in more detail above.

The second element of the invention is a micromanipulation device that controls the function of the disk, specifically rotational motion of the disk. In some embodiments the device also comprises detectors such as optical detectors and radiometric detectors to interrogate specific regions of the disk surface, for example, where a reaction product is located after microfluidic manipulation on the disk surface. This device comprises mechanisms and motors that enable the disk to be loaded and rotated. In addition, the device provides means for a user to operate the microsystems in the disk and access and analyze data, preferably using a keypad and computer display. The micromanipulation device also advantageous provides means for actuation of on-disk elements, such as valves and means for adding fluids to and removing fluids from the discs. In preferred embodiments, the apparatus also comprises means for insulating the platforms of the invention from the environment and maintaining conditions on the platform that are compatible with cell growth, maintenance and viability such as proper temperature, oxygen tension, acidity, humidity levels, and other parameters understood by those with skill in the cell culture arts.

The invention specifically provides microsystems platforms comprising microfluidics components contained in one or a multiplicity of platform layers that are fluidly connected to permit transfer, mixing and assay performance on the sealed surface of the platform. The platforms preferably comprise one or more entry ports through which cell suspensions may be added in volumes ranging from about 1 nL to about 1 mL. The platforms preferably comprise one or more distribution reagent reservoirs containing a sufficient volume, preferably from about 10 nL to about 1 mL, of a distribution reagent solution for a multiplicity of individual assays. The reaction development reservoirs are fluidly connected by microchannels to one or preferably a multiplicity of reaction reservoirs comprising cells having been incubated with one or a plurality of drugs for which drug metabolism, cytotoxicity or cell membrane permeability is tested. In preferred embodiments, the distribution reagent reservoirs are fluidly connected to a manifold or other microfluidic device which is then fluidly connected to one or a plurality of reaction reservoirs for aliquoting specific amounts of the distribution reagent to each of the plurality of reaction reservoirs. In certain embodiments, the platform comprises a multiplicity mixing channels and reservoirs for the mixing of cells with one or a plurality of drugs in various ratios and for the creation of dilution series for performing cell-based assays of drugs and other compounds.

In the use of the platforms of the invention, fluids (including cell suspensions and reagents) are added to the platform when the platform is at rest. Thereafter, rotation of the platform on a simple motor motivates fluid movement through microchannels for various processing steps. In preferred embodiments, the platforms of the invention permit the use of a detector, most preferably an optical detector, for detecting the products of an assay, most preferably a biochemical assay, whereby the assay reaction chambers comprise optical cuvettes, preferably positioned at the outer edge of the platform, and most preferably wherein the platform is scanned past a fixed detector through the action of the rotary motor. Because the platforms of the invention are most preferably constructed using microfabrication techniques as described more fully below, the volumes of fluids used may be made arbitrarily small as long as the detectors used have sufficient sensitivity.

The present invention solves problems in the current art through the use of a microfluidic disk in which centripetal acceleration is used to move fluids. It is an advantage of the microfluidics platforms of the present invention that the fluid-containing components are constructed to contain small volumes, thus reducing reagent costs, reaction times and the amount of biological material required to perform an assay. It is also an advantage that the fluid-containing components are sealed, thus eliminating experimental error due to differential evaporation of different fluids and the resulting changes in reagent concentration, as well as reducing the risk of contamination, either of the cell culture or the operator. Because the microfluidic devices of the invention are completely enclosed, both evaporation and optical distortion are reduced to negligible levels. The platforms of the invention also advantageously permit “passive” mixing and valving, i.e., mixing and valving are performed as a consequence of the structural arrangements of the components on the platforms (such as shape, length, position on the platform surface relative to the axis of rotation, and surface properties of the interior surfaces of the components, such as wettability as discussed below), and the dynamics of platform rotation (speed, acceleration, direction and change-of-direction), and permit control of assay timing and reagent delivery. In certain embodiments, mixing of cells with one or a plurality of solutions comprising one or a plurality of drugs to be tested is effectuated by concomitant flow through a microchannel fluidly-connected with a loading (sample inlet) port.

In alternative embodiments of the platforms of the invention, and particularly relating to microfluidics structures involved in fluid flow of distribution reagents on the platforms of the invention, metering structures as disclosed in co-owned U.S. Pat. No. 6,063,589, issued May 16, 2000 and incorporated by reference herein, are used to distribute defined aliquots of a distribution reagent to each of a multiplicity of reaction reservoirs, thereby permitting parallel processing and mixing of a plurality of samples with the distribution reagent . This reduces the need for automated distribution reagent distribution mechanisms, reduces the amount of time required for distribution reagent dispensing (that can be performed in parallel with distribution of said distribution reagent to a multiplicity of reaction reservoirs), and permits delivery of small (nL-to-μL) volumes without using eternally-applied electromotive means. It also enables the performance of multiplexed assays, in which cell populations may be divided and the microfluidics of the device used to perform a variety of assays on different sub-populations in parallel, on one population serially, or on a single population simultaneously.

The assembly of a multiplicity of cell incubation chambers on the platforms of the invention also permits simplified detectors to be used, whereby each individual reaction reservoir can be scanned using mechanisms well-developed in the art for use with, for example, CD-ROM technology.

Finally, the platforms of the invention are advantageously provided with sample and reagent entry ports for filling with samples and reagents, respectively, that can be adapted to liquid delivery means known in the art (such as micropipettors). Additionally, the platforms of the invention are advantageously provided with reaction extraction ports, preferably comprising a pierceable membrane, whereby liquid comprising a product or byproduct of drug metabolism can be extracted from the platform using means known in the art (such as a syringe or micropipettor).

The platforms of the invention reduce the demands on automation in at least three ways. First, the need for precise metering of fluids such as distribution reagents is relaxed through the use of on-disk metering structures, as described more fully in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein, the disclosures of each of which are explicitly incorporated by reference herein. By loading imprecise volumes, in excess of those needed for the assay, and allowing the rotation of the disk and use of appropriate microfluidic structures to meter the fluids, much simpler (and less expensive) fluid delivery technology may be employed than is the conventionally required for high-density microtitre plate assays.

Second, the total number of fluid “delivery” events on the microfluidic platform is reduced relative to conventional assay devices such as microtiter plates. By using microfluidic structures that sub-divide and aliquot common reagents(such as distribution reagents) used in all assays performed on the platform, the number of manual or automated pipetting steps are reduced by at least half (depending on the complexity of the assay). Examples of these structures have been disclosed in co-owned U.S. Pat. No. 6,063,589, issued May 16, 2000, and incorporated by reference herein. These structures provide automation, for example, for serial dilution assays, a laborious process when performed conventionally. This process is replaced by “parallel dilution” on the platforms of the invention.

Finally, the invention also provides on-platform means for extracting liquid comprising drug products, by-products or metabolites from the platform for further analysis, such as by liquid chromatography, high-pressure chromatography, mass spectrometry, or combinations thereof.

Certain preferred embodiments of the apparatus of the invention are described in greater detail in the following sections of this application and in the drawings.

### BRIEF DESCRIPTION OF THE DRAWINGS

FIG. 1 shows a rotatable disk with one partial microfluidic structure for cell extraction.

FIG. 2 shows one partial microfluidic structure for cell extraction. The distribution manifold channel 316 connects to several other microfluidics structures.

FIGS. 3a through 3m shows the sequential process of loading fluids and processing those fluids within the microfluidic structure.

FIGS. 4a and 4b show a detailed view of the reaction reservoir 306.

FIGS. 5a through 5c show the sequential process of sample extraction from the rotatable disc.

FIG. 6 shows exemplary data from a metabolic clearance cell-based assay.

### DETAILED DESCRIPTION OF PREFERRED EMBODIMENTS

This invention provides a microplatform and a micromanipulation device as disclosed in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein, adapted for performing cell-based microanalytical and microsynthetic assays of biological samples.

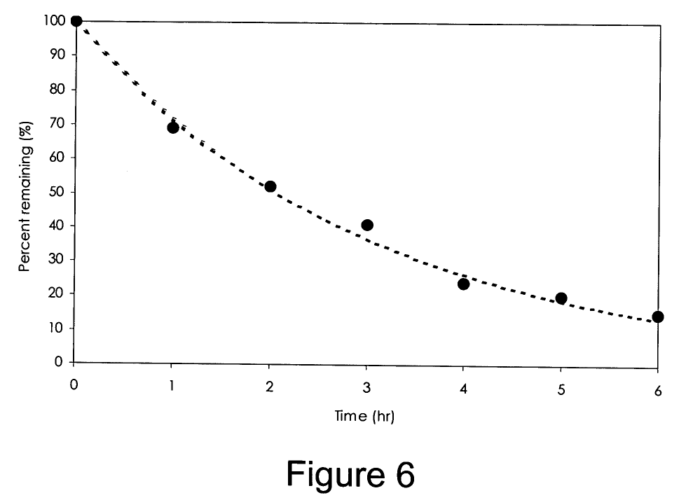

In certain embodiments, the Microsystems platforms of the invention are useful for performing in vitro drug behavior assays. Often, it is most convenient to express the drug clearance as the concentration of the drug remaining over time. In a closed system, the drug concentration is expected to exponentially decay over time, and therefore a half-life for drug clearance can be calculated. To make such determinations, it is useful to measure the concentration at several discrete time points after the initial mixing of the drug and cells, and then fit an exponential curve to the results, as illustrated by example in FIG. 6. When measurements are made for each discrete time point, it is necessary to quench the reaction prior to making the measurement, to ensure that the drug concentration does change further during the measurement process. Although quenching is achievable by many methods, the quickest and most effective is to remove a small sample volume for measurement and mix it thoroughly with an agent that will kill all cells and denature all enzymes in the sample. An example of an agent that quickly achieves these goals is acetonitrile.

The microsystems platforms provided herein can be adapted for use with any detection method known to those having skill in the art appropriate to the assays performed on the disk. These include optical methods (such as absorbance spectroscopy, fluorescence spectroscopy, and luminescence), as well as non-optical methods (including but not limited to radiometry, scintillation, and calorimetry). Depending on what detection method is used to measure the drug concentration in each time point, it is usually necessary to separate the cells or cell fragments from the sample prior to measurement. All optical methods (including fluorescence, luminescence and absorbance) are susceptible to optical interference from cells and cells fragments that are large enough to absorb and defract light of any wavelength. The most readily available method of separating cells and cell fragments from the sample is centrifugation, which collects cells and cell fragments in a pellet, leaving the aqueous phase of the sample as a liquid supernatant. The rotatable platform used in this invention is ideal for cell-based assays because the method used of moving fluids, centrifugal microfluidics, can also be used to separate cell and cell debris from. samples.

For the purposes of this invention, the term “sample” will be understood to encompass any fluid, solution or mixture, either isolated or detected as a constituent of a more complex mixture, or synthesized from precursor species. In particular, the term “sample” will be understood to encompass any biological species of interest. The term “biological sample” or “biological fluid sample” will be understood to mean any biologically-derived sample comprising a cell suspension, including cultured cells, cells obtained in primary culture from organs, hematopoietic cells, and tumor cells, preferably comprising specific cell types, most preferably wherein the specific cell type is a hepatocyte.

For the purposes of this invention, the term “a centripetally motivated fluid micromanipulation apparatus” is intended to include analytical centrifuges and rotors, microscale centrifugal separation apparatuses, and most particularly the microsystems platforms and disk handling apparatuses as described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

For the purposes of this invention, the term “microsystems platform” is intended to include centripetally-motivated microfluidics arrays as described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

For the purposes of this invention, the terms “capillary”, “microcapillary” and “microchannel” will be understood to be interchangeable and to be constructed of either wetting or non-wetting materials where appropriate, and to have an internal diameter less than about 500 microns. In particular embodiments are provided reverse feed channels, particularly serpentine microchannels, which are microchannels containing at least one bend of at least 90 degrees, and wherein the at least one bend directs fluid flow in a direction parallel to, or towards, the center of rotation of the platform.

For the purposes of this invention, the term “reaction reservoir” “assay chamber,” “collection chamber” and “detection chamber” will be understood to mean a defined volume on a Microsystems platform of the invention comprising a fluid.

For the purposes of this invention, the terms “entry port,” “loading port,” “sample input port” and “fluid input port” will be understood to mean an opening on a microsystems platform of the invention comprising a means for applying a fluid to the platform.

For the purposes of this invention, the terms “exit port,” “extraction port” and “fluid outlet port” will be understood to mean a defined volume on a microsystems platform of the invention comprising a means for removing a fluid from the platform.

For the purposes of this invention, the terms “capillary junction” will be understood to mean a region in a capillary or other flow path where surface or capillary forces are exploited to retard or promote fluid flow. A capillary junction is provided as a pocket, depression or chamber in a hydrophilic substrate that has a greater depth (vertically within the platform layer) and/or a greater width (horizontally within the platform layer) that the fluidics component (such as a microchannel) to which it is fluidly connected. For liquids having a contact angle less than 90° (such as aqueous solutions on platforms made with most plastics, glass and silica), flow is impeded as the channel cross-section increases at the interface of the capillary junction. The force hindering flow is produced by capillary pressure, that is inversely proportional to the cross sectional dimensions of the channel and directly proportional to the surface tension of the liquid, multiplied by the cosine of the contact angle of the fluid in contact with the material comprising the channel. The factors relating to capillarity in microchannels according to this invention have been discussed in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768.

Capillary junctions can be constructed in at least three ways. In one embodiment, a capillary junction is formed at the junction of two components wherein one or both of the lateral dimensions of one component is larger than the lateral dimension(s) of the other component. As an example, in microfluidics components made from “wetting” or “wettable” materials, such a junction occurs at an enlargement of a capillary as described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768. Fluid flow through capillaries is inhibited at such junctions. At junctions of components made from non-wetting or non-wettable materials, on the other hand, a constriction in the fluid path, such as the exit from a chamber or reservoir into a capillary, produces a capillary junction that inhibits flow. In general, it will be understood that capillary junctions are formed when the dimensions of the components change from a small diameter (such as a capillary) to a larger diameter (such as a chamber) in wetting systems, in contrast to non-wettable systems, where capillary junctions form when the dimensions of the components change from a larger diameter (such as a chamber) to a small diameter (such as a capillary).

A second embodiment of a capillary junction is formed using a component having differential surface treatment of a capillary or flow-path. For example, a channel that is hydrophilic (that is, wettable) may be treated to have discrete regions of hydrophobicity (that is, non-wettable). A fluid flowing through such a channel will do so through the hydrophilic areas, while flow will be impeded as the fluid-vapor meniscus impinges upon the hydrophobic zone.

The third embodiment of a capillary junction according to the invention is provided for components having changes in both lateral dimension and surface properties. An example of such a junction is a microchannel opening into a Those of ordinary skill will appreciate how capillary junctions according to the invention can be created at the juncture of components having different sizes in their lateral dimensions, different hydrophilic properties, or both.

For the purposes of this invention, the term “capillary action” will be understood to mean fluid flow in the absence of rotational motion or centripetal force applied to a fluid on a rotor or platform of the invention and is due to a partially or completely wettable surface.

For the purposes of this invention, the term “capillary microvalve” will be understood to mean a capillary microchannel comprising a capillary junction whereby fluid flow is impeded and can be motivated by the application of pressure on a fluid, typically by centripetal force created by rotation of the rotor or platform of the invention. Capillary microvalves will be understood to comprise capillary junctions that can be overcome by increasing the hydrodynamic pressure on the fluid at the junction, most preferably by increasing the rotational speed of the platform.

For the purposes of this invention, the term “in fluid communication” or “fluidly connected” is intended to define components that are operably interconnected to allow fluid flow between components.

For the purposes of this invention, the term “air displacement channels” will be understood to include ports in the surface of the platform that are contiguous with the components (such as microchannels, chambers and reservoirs) on the platform, and that comprise vents and microchannels that permit displacement of air from components of the platforms and rotors by fluid movement.

For the purposes of this invention, the term “distribution reagent” is intended to encompass a reagent that stops a reaction occurring in the reaction reservoir, for example, drug metabolism in hepatocytes according to one embodiment of the invention. An advantageous agent for quenching cell-based reactions by, inter alia, lysing the cells is acetonitrile. Alternative embodiments include, in non-limiting examples, precipitating agents, fluorophores, enzymes, and antibodies.

The microplatforms of the invention (preferably and hereinafter collectively referred to as “disks”; for the purposes of this invention, the terms “microplatform”, “microsystems platform” and “disk” are considered to be interchangeable) are provided to comprise one or a multiplicity of microsynthetic or microanalytic systems (termed “microfluidics structures” herein). Such microfluidics structures in turn comprise combinations of related components as described in further detail herein that are combinations of related components as described in further detail herein that are operably interconnected to allow fluid flow between components upon rotation of the disk. These components can be microfabricated as described below either integral to the disk or as modules attached to, placed upon, in contact with or embedded in the disk. For the purposes of this invention, the term “microfabricated” refers to processes that allow production of these structures on the sub-millimeter scale. These processes include but are not restricted to molding, photolithography, etching, stamping and other means that are familiar to those skilled in the art.

The invention also comprises a micromanipulation device for manipulating the disks of the invention, wherein the disk is rotated within the device to provide centripetal or centrifugal force to effect fluid flow on the disk. Accordingly, the device provides means for rotating the disk at a controlled rotational velocity, for stopping and starting disk rotation, and advantageously for changing the direction of rotation of the disk. Both electromechanical means and control means, as further described herein, are provided as components of the devices of the invention. User interface means (such as a keypad and a display) are also provided, as further described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

The invention provides a combination of specifically-adapted microplatforms that are rotatable, analytic/synthetic microvolume assay platforms, and a micromanipulation device for manipulating the platform to achieve fluid movement on the platform arising from centripetal force on the platform as result of rotation. The platform of the invention is preferably and advantageously a circular disk; however, any platform capable of being rotated to impart centripetal for a fluid on the platform is intended to fall within the scope of the invention. The micromanipulation devices of the invention are more fully described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,70 6,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

Fluid (including reagents, samples, particularly cell suspensions and solutions comprising one or a plurality to be tested, distribution reagents, and other liquid components) movement is controlled by centripetal acceleration due to rotation of the 15 platform. The magnitude of centripetal acceleration required for fluid to flow at a rate and under a pressure appropriate for a particular microfluidics structure on the microsystems platform is determined by factors including but not limited to the effective radius of the platform, the interior diameter of microchannels, the position angle of the microchannels on the platform with respect to the direction of rotation, and the speed of rotation of the platform. In certain embodiments of the methods of the invention an unmetered amount of a fluid (herein, for example, a solution comprising a distribution reagent) is applied to the platform in an unmetered about and a metered amount is transferred from a fluid reservoir to a microchannel, as described in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,706,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein. In preferred embodiments, the metered about 500 μL. In these embodiments, metering manifolds comprising one or a multiplicity of metering capillaries are provided to distribute the fluid to a plurality of components of the microfluidics structure.

The components of the platforms of the invention are in fluidic contract with one another. In preferred embodiments, fluidic contact is provided by microchannels comprising the surface of the platforms of the invention. Microchannel sizes are optimally determined by specific applications and by the amount of and delivery rates of fluids required for each particular embodiment of the platforms and methods of the invention. Microchannel sizes can range from 0.1 μm to a value close to the thickness of the disk (e.g., about 1 mm); in preferred embodiments, the interior dimension of the microchannel is from 0.5 μm to about 500 μm. Microchannel and reservoir shapes can be trapezoid, circular or other geometric shapes as required. Microchannels preferably are embedded in a microsystem platform having a thickness of about 0.1 to 25 mm, wherein the cross-sectional dimension of the microchannels across the thickness dimension of the platform is less than 1 mm, and can be from 1 to 90 percent of said cross-sectional dimension of the platform. Reaction reservoirs, reagent reservoirs, collection chambers, detections chambers and sample inlet and outlet ports preferably are embedded in a microsystem platform having a thickness of about 0.1 to 25 mm, wherein the cross-sectional dimension of the microchannels across the thickness dimension of the platform is from 1 to 75 percent of said cross-sectional dimension of the platform. In preferred embodiments, delivery of fluids through such channels is achieved by the coincident rotation of the platform for a time and at a rotational velocity sufficient to motivate fluid movement between the desired components.

The flow rate through a microchannel of the invention is inversely proportional to the length of the longitudinal extent or path of the microchannel and the viscosity of the fluid and directly proportional to the product of the square of the hydraulic diameter of the microchannel, the square of the rotational speed of the platform, the average distance of the fluid in the channels from the center of the disk and the radial extent of the fluid subject to the centripetal force. Since the hydraulic diameter of a channel is proportional to the ratio of the cross-sectional area to cross-sectional perimeter of a channel, one can judiciously vary the depth and width of a channel to affect fluid flow (see Duffy et al., 1998, Anal. Chem. 71: 4669-4678 and co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, 2003; U.S. Pat. No. 6,70 6,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, incorporated by reference).

For example, fluids of higher densities flow more rapidly than those of lower densities given the same geometric and rotational parameters. Similarly, fluids of lower viscosity flow more rapidly than fluids of higher viscosity given the same geometric and rotational parameters. If a microfluidics structure is displaced along the radial direction, thereby changing the average distance of the fluid from the center of the disk but maintaining all other parameters, the flow rate is affected: greater distances from the center result in greater flow rates. An increase or a decrease in the radial extent of the fluid also leads to an increase or decrease in the flow rate. These dependencies are all linear. Variation in the hydraulic diameter results in a quartic dependence of flow rate on hydraulic diameter (or quadratic dependence of fluid flow velocity on hydraulic diameter), with larger flow rates corresponding to larger diameters. Finally, an increase in the rotational rate results in a quadratic increase in the flow rate or fluid flow velocity.

As disclosed herein, the microfluidics structures of the Microsystems platforms of the invention are arranged to take advantage of said differences in fluid flow rate due to differences in fluid viscosities. For example, mixing of fluids comprising cell suspensions, particularly hepatocyte cell suspensions, which typically have viscosities greater than the viscosity of water, and solutions comprising one or a plurality of drugs to be tested, which typically have viscosities about equal to the viscosity of water, is effected by concomitant travel of said solutions through microchannels fluidly connecting the loading (sample input) port and the reaction reservoir. In these embodiments, fluid flow of said fluids of different viscosities results in mixing without the need for any specialized or mechanical mixing structures, which would be deleterious to the integrity of cells,

Input and output (entry and exit) ports are components of the microplatforms of the invention that are used for the introduction or removal of fluid components. Entry ports (also termed “loading ports” and “sample input ports” interchangeably herein) are provided to allow samples and reagents to be placed on or injected onto the disk; these types of ports are generally located towards the center of the disk. As used herein, these ports are adapted to receive cell suspensions and solutions comprising one or a plurality of drugs to be tested, wherein the ports are specifically adapted to receive one or a plurality of said drug-containing solutions and said cell suspensions, and thus are fabricated to have a total volume sufficient to accommodate said plurality of liquids added concomitantly or sequentially to the Microsystems platforms of the invention. Exit ports (also termed “extraction ports” herein) are also provided to allow products to be removed from the disk. In certain embodiments, said exit ports are provided as a portion of the reaction reservoirs of the invention. Examples of these embodiments include reaction reservoirs shaped to set off a portion of the reservoir, preferably a portion more proximal to the center of rotation that the remainder of the reservoir. Also included are embodiments wherein the exit port has a cross-sectional dimension from the top to the bottom of the platform that is deeper in the exit port portion than in the remainder of the reservoir, wherein, for example, the lower surface of the reservoir slopes in a direction towards the center of rotation. In certain embodiments, the upper surface of the exit port is covered by a pierceable membrane adapted for insertion of a micropipette or syringe. Port shape and design vary according specific applications. For example, sample input ports are designed, inter alia, to allow capillary action to efficiently draw the sample into the disk. In addition, ports can be configured to enable automated sample/reagent loading or product removal. Entry and exit ports are most advantageously provided in arrays, whereby multiple samples are applied to the disk or to effect product removal from the microplatform.

In some embodiments of the platforms of the invention, the inlet and outlet ports are adapted to the use of manual pipettors and other means of delivering fluids to the reservoirs of the platform. In alternative, advantageous embodiments, the platform is adapted to the use of automated fluid loading devices. One example of such an automated device is a single pipette head located on a robotic arm that moves in a direction radially along the surface of the platform. In this embodiment, the platform could be indexed upon the spindle of the rotary motor in the azimuthal direction beneath the pipette head, which would travel in the radial direction to address the appropriate reservoir.

Another embodiment is a pipettor head adapted to address multiple loading ports, either a subset of or all of the loading ports on the platform surface. For embodiments where the pipettor head addresses a subset of the loading ports, a single head may for example be composed of a linear array of pipette heads. In other embodiments, pipette heads may be used which can simultaneously address all entry ports (for example, a 96-tip head).

Also included in air handling systems on the disk are air displacement channels, whereby the movement of fluids displaces air through channels that connect to the fluid-containing microchannels retrograde to the direction of movement of the fluid, thereby providing a positive pressure to further motivate movement of the fluid.

Platforms of the invention such as disks and the microfluidics components comprising such platforms are advantageously provided having a variety of composition and surface coatings appropriate for particular applications. Platform composition will be a function of structural requirements, manufacturing processes, and reagent compatibility/chemical resistance properties. Specifically, platforms are provided that are made from inorganic crystalline or amorphous materials, e.g. silicon, silica, quartz, inert metals, or from organic materials such as plastics, for example, poly(methyl methacrylate) (PMMA), acetonitrile-butadiene-styrene (ABS), polycarbonate, polyethylene, polystyrene, polyolefins, polypropylene and metallocene. These may be used with unmodified or modified surfaces as described below. The platforms may also be made from thermoset materials such as polyurethane and poly(dimethyl siloxane) (PDMS). Also provided by the invention are platforms made of composites or combinations of these materials; for example, platforms manufactured of a plastic material having embedded therein an optically transparent glass surface comprising the detection chamber of the platform. Alternately, platforms composed of layers made from different materials may be made. The surface properties of these materials may be modified for specific applications, as disclosed in co-owned U.S. Pat. No. 6,063,589, issued May 16, 2000; U.S. Pat. No. 6,143,247, issued Nov. 7, 2000; U.S. Pat. No. 6,143,248, issued Nov. 7, 2000; U.S. Pat. No. 6,302,134, issued Oct. 16, 2001; U.S. Pat. No. 6,319,468, issued Nov. 20, 2001; U.S. Pat. No. 6,319,469, issued Nov. 20, 2001; U.S. Pat. No. 6,399,361, issued Jun. 4, 2002; U.S. Pat. No. 6,527,432, issued Mar. 4, 2003; U.S. Pat. No. 6,548,788, issued Apr. 15, 2003; U.S. Pat. No. 6,582,662, issued Jun. 24, 2003; U.S. Pat. No. 6,632,399, issued Oct. 14, 2003; U.S. Pat. No. 6,656,430, issued Dec. 3, Jun. 24, 2003; U.S. Pat. No. 6,632,399, issued Oct. 14, 2003; U.S. Pat. No. 6,656,430, issued Dec. 3, 2003; U.S. Pat. No. 6,70 6,519, issued Mar. 16, 2004; U.S. Pat. No. 6,709,869, issued Mar. 23, 2004; U.S. Pat. No. 6,719,682, issued Apr. 13, 2004; and co-owned International Patent Applications, Publication Nos. WO97/21090; WO98/07019; WO98/28623; WO98/53311; WO00/69560; WO00/78455; WO00/79285; WO01/87485; WO01/87486; WO01/87487; WO01/87768, the disclosures of each of which are explicitly incorporated by reference herein.

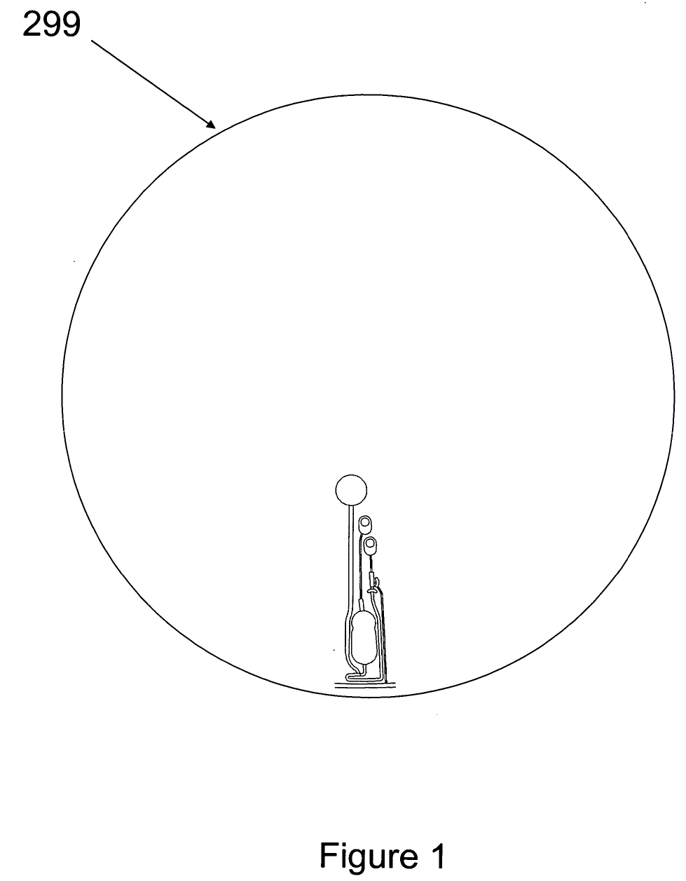

Preferably, the disk incorporates microfabricated mechanical, optical, and fluidic control components on platforms made from, for example, plastic, silica, quartz, metal or ceramic. These structures are constructed on a sub-millimeter scale by molding, photolithography, etching, stamping or other appropriate means, as described in more detail below. It will also be recognized that platforms comprising a multiplicity of the microfluidic structures are also encompassed by the invention, wherein individual combinations of microfluidics and reservoirs, or such reservoirs shared in common, are provided fluidly connected thereto. An example of such a platform is shown in FIG. 1.

Platform Manufacture and Assembly

Referring now to the Figures for a more thorough description of the invention, FIG. 1 shows a single embodiment of a microfluidic array for performing cell-based assays according to the invention on a rotatable disk 299. As provided herein, microsystems platforms of the invention are advantageously provided comprising a plurality of microfluidic arrays on the disk. FIG. 1 shows the orientation of the microfluidic arrays relative to the center of rotation. In certain embodiments, the disk further comprises a distribution reagent reservoir 350 (not shown) fluidly connected to each of a plurality of microfluidics arrays as shown in FIG. 1, more preferably all of the microfluidics arrays on the disk, wherein the distribution reagent is distributed through microchannels to each of the plurality of microfluidics arrays under the appropriate rotational speed as exemplified below. A multiplicity of identical assays can be performed on a platform having repeating assay structures around the disk at a particular radius positioned at equivalent distances from the axis of rotation, as well as modifying the structures for placement at different radial positions. In this way, it is possible to fully cover the surface of the disk with microfluidics structures for performing assays. The maximum number of assays that may be i.e., the minimum reproducible dimensions with which the disk may be fabricated, and the amount of hydrodynamic pressure required to drive small volumes of fluid through microchannels at convenient rotational rates. Taking these considerations into account, it is estimated that greater than 10,000 assays having volumes of 1-5 nL can be created in a circular platform having a 5-10 cm radius.

Platform 299 is preferably provided in the shape of a disc, a circular planar platform having a diameter of from about 10 mm to about 100 mm and a thickness of from about 0.1 mm to about 25 mm. Each layer comprising the platform preferably has a diameter that is substantially the same as the other layers, although in some embodiments the diameters of the different layers are not required to completely match. Each layer has a thickness ranging from about 0.1 mm to about 25 mm, said thickness depending in part on the volumetric capacity of the microfluidics components contained therein.

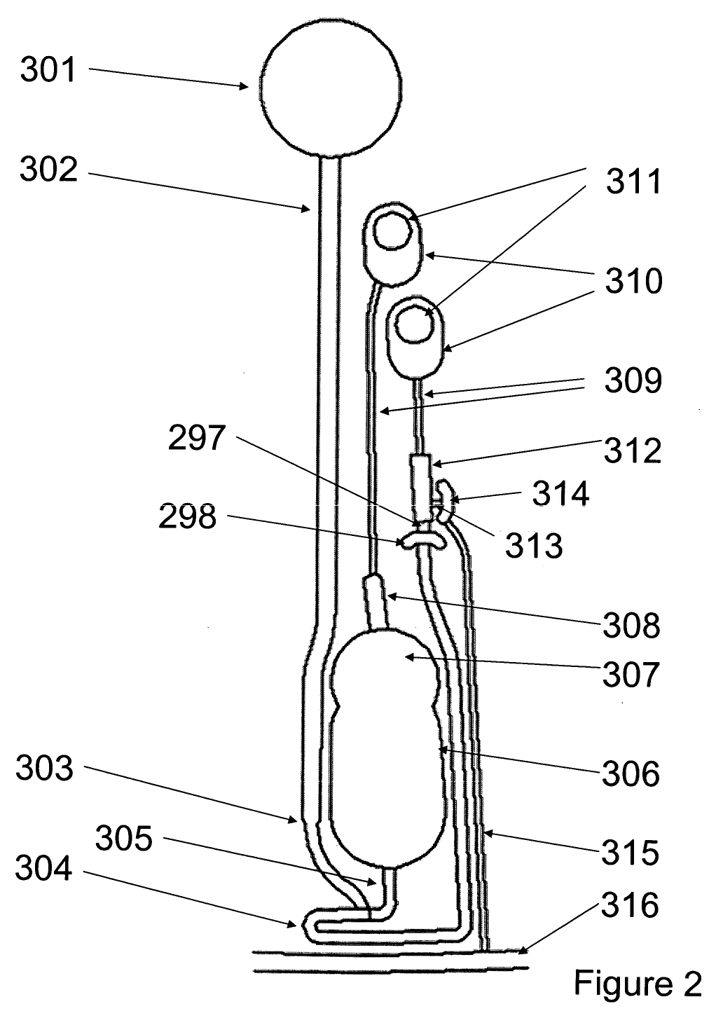

FIG. 2 shows a more detailed view of a microfluidic array of the invention. In this embodiment, a loading port 301 is provided having a diameter of about 1 mm to 20 mm, and a depth of from about 1 mm to about 20 mm and having a volume of from about 0.5 μL to about 6 mL, more preferably from about 0.5 μL to about 1 mL, and more preferably 0.5 μL to about 01 mL, adapted to contain a cell suspension and one or a plurality of liquid samples comprising a drug or drugs to be tested. Loading port 301 can be open to the air to be easily accessed by a pipette tip or other means for introducing liquids onto the disk. Loading port 301 is in fluid communication with a feed channel 302, arrayed on the disk to transfer liquids introduced onto the disk from loading port 301 to reaction reservoir 306, motivated by centrifugal force produced by rotation of the platform. Feed channel 302 has an interior diameter and depth of from about 50 microns to about 5 mm, wherein the interior dimensions is sufficient to permit mixing of fluid volume of the cell suspension with the one or plurality of fluid volumes containing the drug or drugs to be tested. Feed channel 302 is preferably sized such that the residence time within the channel of a fluid element under centrifugal flow is sufficient to allow diffusional mixing across the diameter of the channel. In addition, the length of feed channel 302 is about 1 mm to about 500 mm and can be adapted to regulate the amount of time required to traverse the distance on the disk from loading port 301 to reaction reservoir 306, thereby producing different reaction incubation times for samples loaded onto the disk at the same time. Additionally, said different lengths can be used to ensure mixing of a plurality of liquid samples applied to the disk, whereby longer feed channels 302 are advantageously used to permit mixing of a greater number of liquid samples (cell suspensions+drug-containing liquids). Feed channel 302 may optionally include a necking 303, comprising a constriction in the interior diameter of feed channel 302, wherein the interior dimensions of feed channel 302 are constricted up to about 50% at necking 303. Necking 303 is useful, inter alia, where fluid flow or liquid mixing is facilitated by having the interior dimension of feed channel 302 be wider in proximity to loading port 301 than it is in proximity to reaction reservoir 306. Feed channel 302, or necking 303 when present, is fluidly connected to serpentine channel 304, having at least one bend in the longitudinal extent of the channel that is parallel to, or turned in the direction of, the center of rotation of the platform. Reverse feed channel 304, preferably serpentine channel 304 having a length of from about 5 microns to about 5 mm, an interior dimension of from about 5 microns to about 5 mm, and a depth of from about 5 microns to about 5 mm, and is in fluid communication with blocking channel 305, having a length of from about 5 microns to about 5 mm, an interior dimension of from about 5 microns to about 5 mm, and a depth of about 5 microns to about 5 mm, which is fluidly connected to reaction serpentine channel 304 and blocking channel 305 are smaller, and can be much smaller in size than the interior dimension of feed channel 303. As shown in FIG. 2, reaction reservoir 306 has a total length of about 0.1 mm to about 20 mm, a total width of about 0.1 mm to about 20 mm, a depth (in the non-circular portion) of about 0.1 mm to about 20 mm, and a volume of from about 1 nL to about 8 mL, more preferably from about 1 nL to 1 mL, and more preferably 100 nL to 1 mL, and is arranged on the disk so that the fluid connection between the reaction reservoir and blocking channel 305 is at least slightly more proximal to the center of rotation than the junction between serpentine channel 304 and feed channel 302 (or necking 303 when present). Fluid flow, reservoir depth and capillary action, or any combination thereof, is sufficient to motivate transfer of the liquids in feed channel 302 into reaction reservoir 306. In advantageous embodiments, reaction reservoir 306 comprises a portion, preferably a circular portion 307 at the end of the reservoir more proximal to the center of rotation and having a diameter of from about 0.1 mm to about 20 mm, a depth of about 0.1 mm to about 20 mm, and a volume of from about 0.25 nL to about 4 μL. Preferably the depth of the circular portion 307 of reaction reservoir 306 is deeper than the depth of the remaining portion of reaction reservoir 306. Portion 307 of reaction reservoir 306 advantageously comprise an exit or extraction port as described above. In alternative embodiments, portion 307 of reaction reservoir 306 comprises an optical detection cuvette, wherein the disk can be interrogated to detect drugs, drug metabolites, drug by-products, cytotoxicity or other features and characteristics of cellular, preferably hepatocyte, drug metabolism. Reaction reservoir 306, or when present portion 307, is fluidly connected to stopping channel 308, for example, having a length of from about 5 microns to about 5 mm, and an interior dimension of from about 5 microns to about 5 mm. Advantageously, the interior dimension of stopping channel 308 is larger, preferably much larger, than the interior dimension of blocking channel 305, Stopping channel 308 is in fluid communication with an air displacement channel 309 having an interior dimension of about 5 microns to about 5 mm, and, in turn, air chamber 310, having an interior dimension of from about 1 mm to about 5 mm, and which contains an air vent 311, which is typically open to the air. Air vent 311 having a diameter of from about 0.1 mm to about 5 mm that permits displacement of air from the microfluidics structure of this array upon centrifugal force-motivated fluid movement, and prevents air blockage of clued movement on the platform.

The microfluidic structure also includes a distribution manifold channel 316 that has an interior dimension of from about 50 microns to about 5 mm, in fluidic communication with distribution reagent reservoir 350 (not shown). Distribution manifold channel 316 carries a common distributed reagent, a distribution reagent, from the distribution reagent reservoir 350 to each of the plurality of reaction reservoirs as set forth herein, and thus has a length dependent on the distance from distribution reagent reservoir 350 and each of the microfluidics structures arrayed on the surface of the disk The distribution reagent 321 is introduced into each individual microfluidic structure by distribution feed channel 315 having a length of from about 1 mm to about 50 mm and an interior dimension of from about 50 microns to about 5 mm that is in fluid communication with an intermediate chamber 312. Intermediate chamber 312 has an interior dimension from about 250 microns to about 5 mm, depth of about 1 mm and a volume from about 15 nL to about 50 μL, and is in fluid communication with an air displacement channel 309 and, in turn, air chamber 310, which contains an air vent 311, which is typically open to the air, permitting air displacement as described above. Intermediate chamber 312 and distribution feed channel 315 in some embodiments are fluidly connected by first capillary microvalve 314 and first connector channel 313, wherein first connector channel 313 has a length of from about 5 microns to about 5 mm, an interior dimension of from about 5 microns to about 5 mm and a depth of from about 5 microns to about 5 mm. Intermediate chamber 312 is also in fluid communication with second connector channel 297 having a length of from about 5 microns to about 5 mm, and an interior dimension of from about 5 microns to about 5 mm, that is in fluid communication with second capillary microvalve 298. First and second capillary microvalves 297 and 298 have a depth of from about 1 to 200 microns. Second capillary microvalve 298 is in fluid connection with serpentine channel 304. Generally, intermediate chamber 315 is positioned on the disk to be more proximal to the center of rotation than the reaction reservoir to which it is fluidly connected.

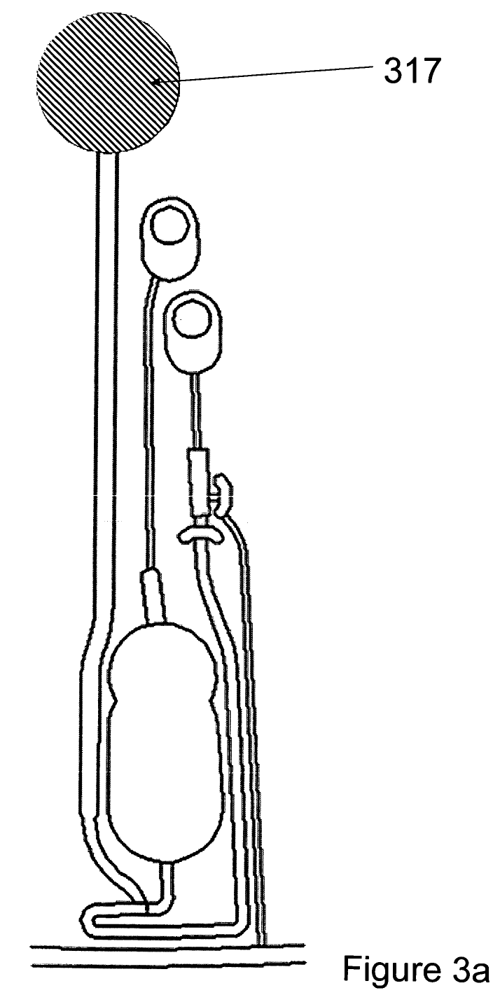

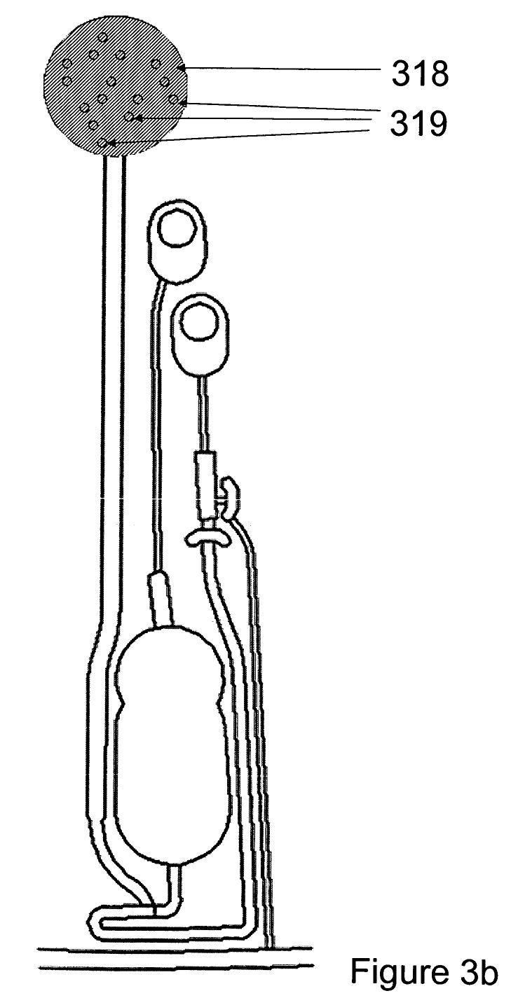

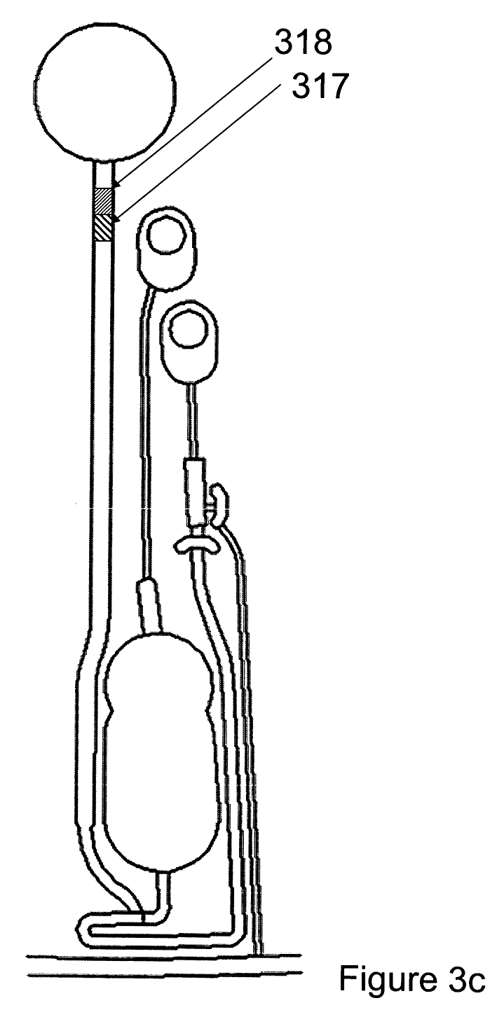

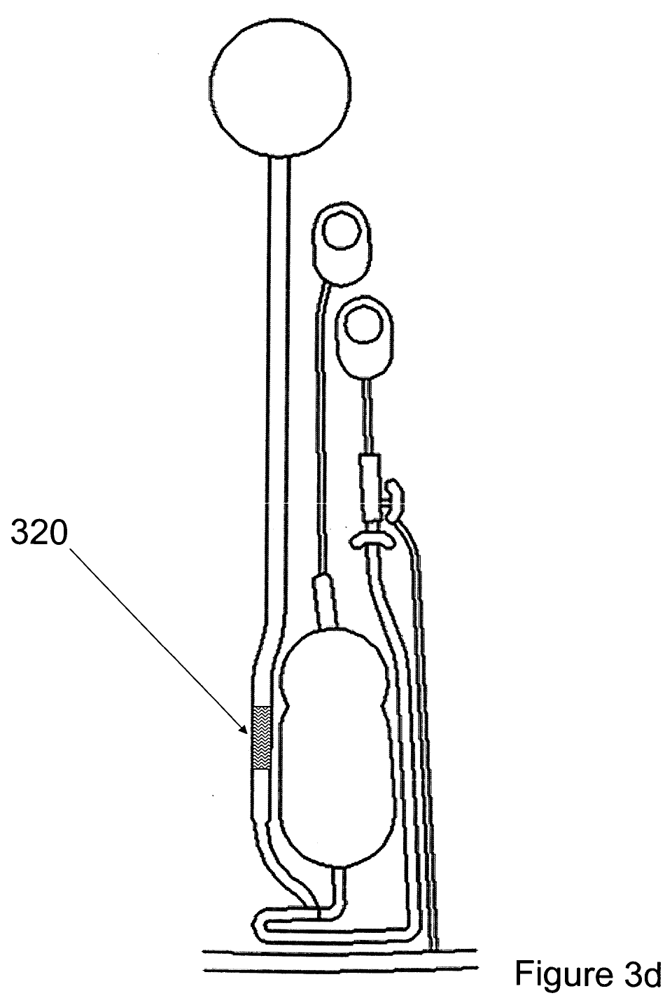

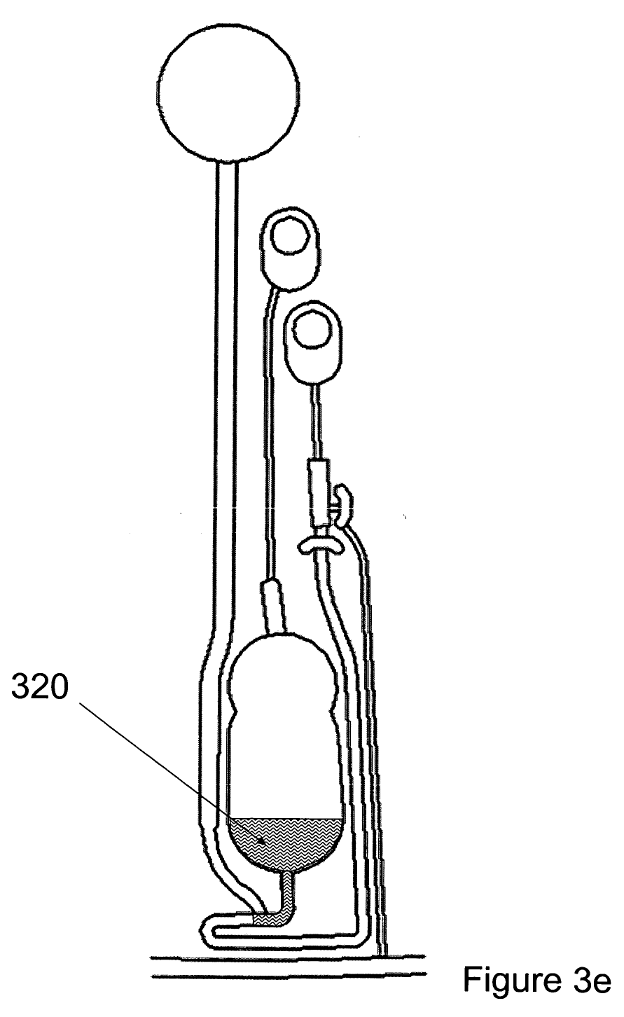

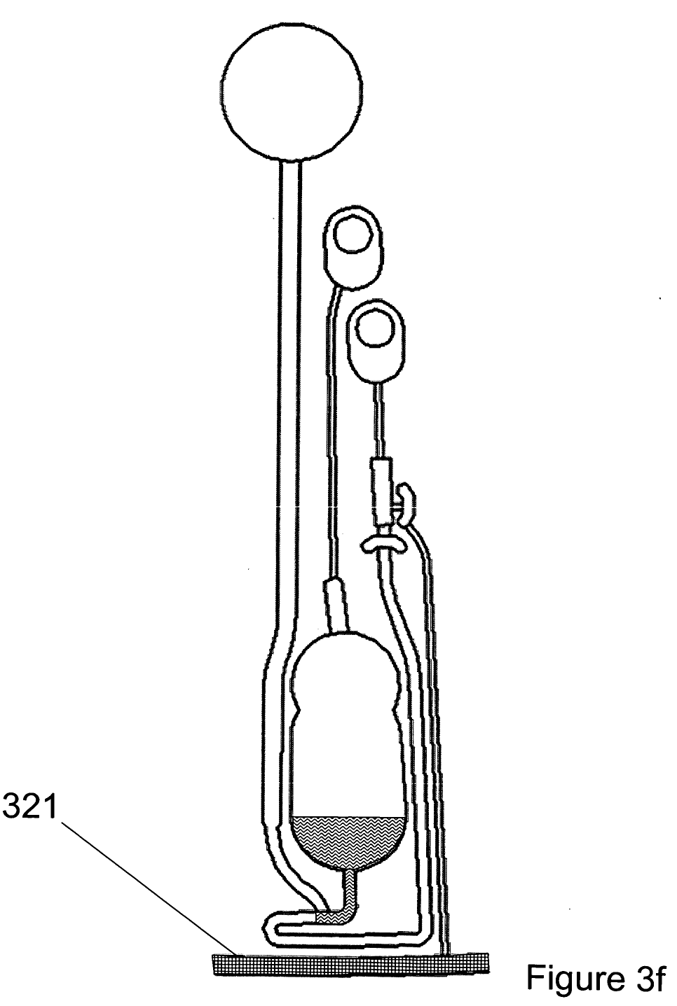

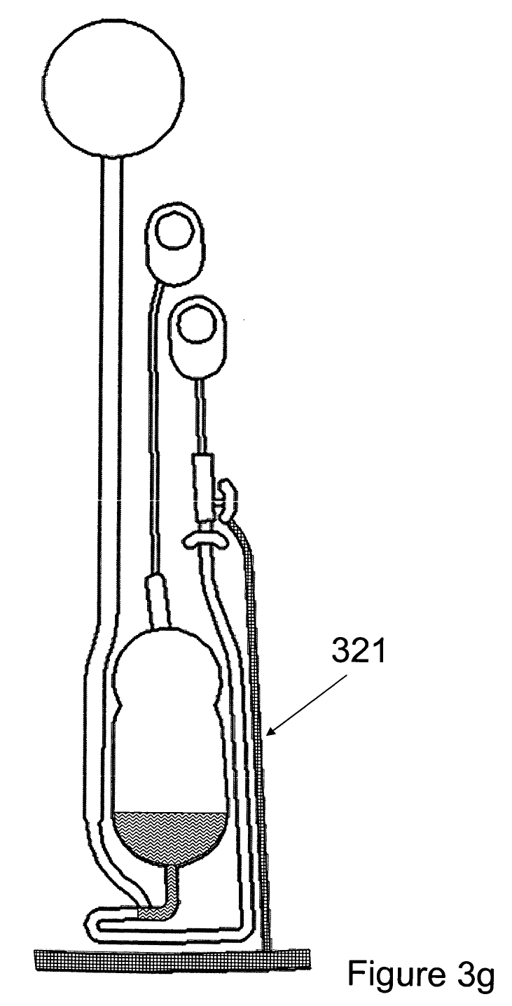

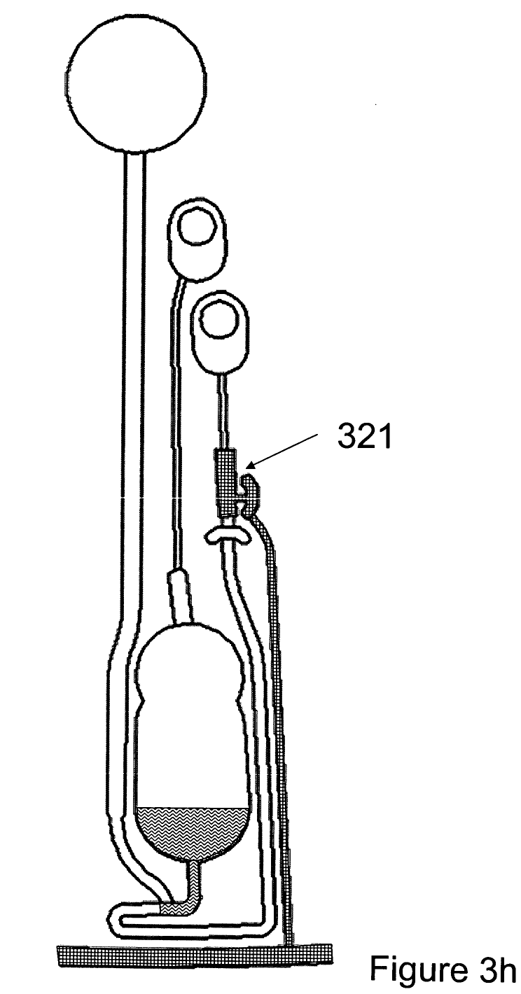

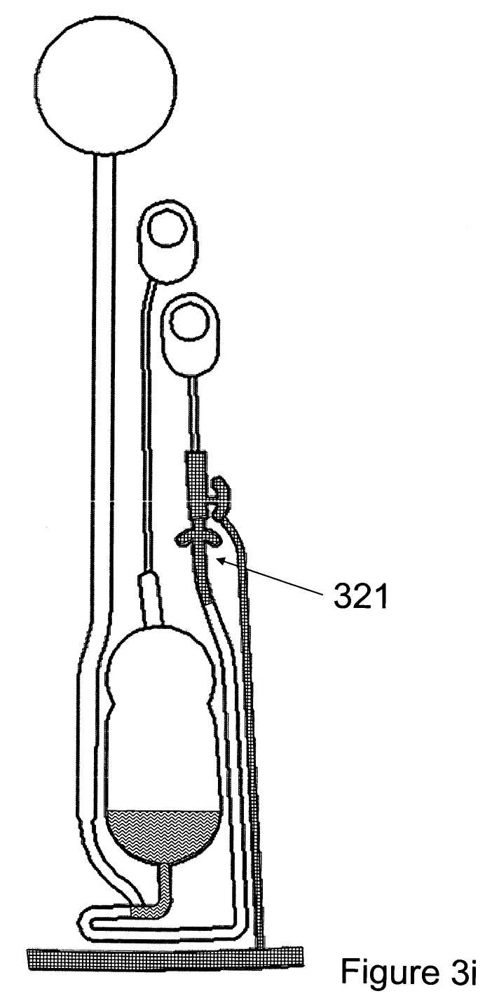

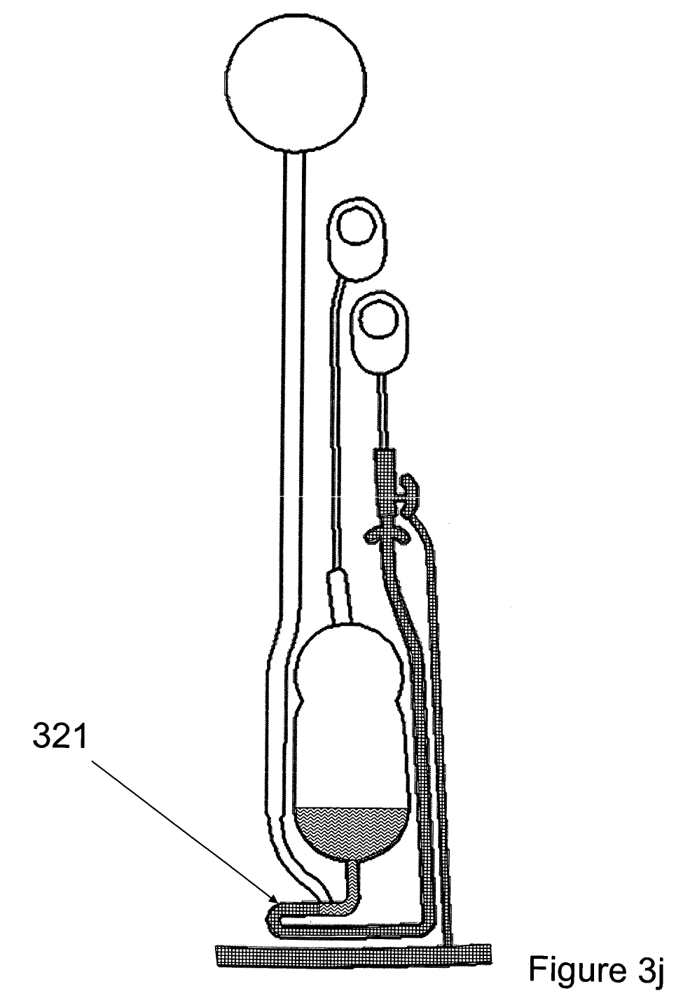

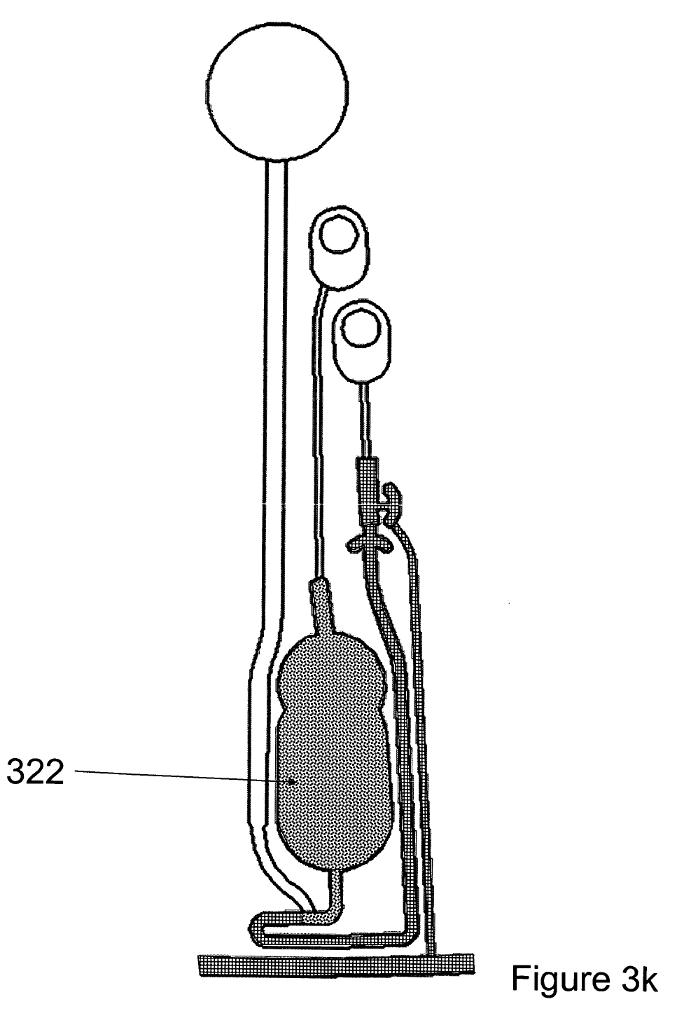

Assays are performed in the following general manner, as shown in FIGS. 3a through 3m: One or a plurality of liquid samples comprising a drug or drugs to be tested are also added to loading port 301 (FIG. 3a). This volume comprises a first liquid plug 317 that can enter feed channel 302, either motivated by platform rotation or by passive capillary action (FIG. 3c). A liquid sample containing cells 319, herein termed a cell suspension, is loaded through loading port 301 (FIG. 3b) The cell suspension comprises a second plug 318 in feed channel 302 (FIG. 3c). In embodiments of the platforms of the invention used for hepatocyte metabolic clearance assays, cells 319 are hepatocytes. The plurality of drug-containing liquid sample can be any number and have any volume that can be accommodated by loading port 301 and can be mixed during transit of the liquid plugs through the longitudinal extent of feed channel 302, so that the mixture is thoroughly mixed during said transit of feed channel 302 or sufficiently mixed that substantially complete mixing is achieved in reaction reservoir 306. After loading, the rotatable disk 299 is spun at a first rotational speed f₁, from about 500 rpm to about 2500 rpm, such that the first plug of fluid 317 and second plug of fluid 318 are transported into feed channel 302, as shown in FIG. 3c.

As further shown in FIG. 3d, the first plug of fluid 317 and the second plug of fluid 318 form a single mixed plug 320 upon transit through feed channel 302. Mixing, and the extent of mixing, is influenced by factors including but not limited to dispersion due to motion through the channel and the density gradient between the first plug of fluid 317 and the second plug of fluid 318. Due to the effects of this density gradient it is advantageous to load the cell suspension liquid last, because this volume, second plug of fluid 318 will contain primarily cell culture medium, which is considerably denser than water. Cells 319 present in second plug of fluid 318 are also substantially denser than water. By comparison, the drug solution(s) comprising the first plug of fluid 317 usually have the same density as water, or sometimes a very slightly higher density. The higher the density of the fluid, the larger the motivational, centrifugal force experienced by that fluid during rotation of disk 299. Therefore, when first plug of fluid 317 is followed in a channel by second plug of fluid 318 having greater density, mixing of the two plugs can be achieved simply through traversing a channel in the same direction as the direction of the centrifugal force. Depending on the density difference between the several plugs of fluid, the dimensions of the channel, the rate of spinning, and other factors, the first plug of fluid 317 and the second plug of fluid 318 may effectively form a single mixed plug 320 in the loading port 301, anywhere in the feed channel 302, or in the reaction reservoir 306.

Mixed plug 320, driven by centrifugal force, eventually enters reaction reservoir 306, as shown in FIG. 3e. Depending on the geometry, it will usually pass through a blocking channel 305 before reaching the reaction reservoir 306, and may also pass through a portion of the serpentine channel 304. Once the mixed plug reaches the reaction reservoir 306, rotation of disk 299 is stopped, and the cell suspension incubated with the one or plurality of said drugs for an incubation period. Alternatively, loading and spinning steps can be performed using different microfluidic structures on the same disk 299. For example, one mixed plug 320 may be created at a first time 0 and allowed to incubate for 1 hour. At that time, a second mixed plug 320 can be created in a second microfluidic structure, and another 1 hour incubation period can be used. At that time, a third mixed plug 320 can be created in a third microfluidic structure. Thus, after 2 total hours of incubation, the samples are 0 hours, 1 hour, and 2 hours old. If the same liquids were used in loading the entry ports, these 3 different samples represent three different time points in the same reaction. This scenario could be used to create a data set such as the exemplary one shown in FIG. 6. Alternatively, different microfluidics arrays can be arranged on the surface of the platform to comprise feed channels 302 of differing lengths, sufficient to provide different reaction times. Furthermore, since all of the structures are on the same disk 299 and are connected to the same distribution manifold channel 316, it is possible to quench all of the reactions, for example with acetonitrile, at the same time.

FIG. 3f shows that mixed plug 320 has been transferred to reaction reservoir 306, and that a distribution reagent 321 is entering the distribution manifold channel 316. In certain embodiments, such as quenching a cell-based drug metabolism reaction, this liquid may be acetonitrile which lyses the cells, effectively stopping any drug metabolism. Alternative distribution reagents include but are not limited to precipitating agents, fluorophores, enzymes, and antibodies.

Distribution reagent 321 is moved by disk rotation at a second rotational speed f₂, from about 500 rpm to about 5000 rpm, to fill distribution manifold channel 316 and then the distribution feed channel 315. The liquid eventually fills the serpentine channel 304, in certain embodiments after possibly passing through first capillary valve 314, first connector channel 313, intermediate chamber 312, second connector channel 297, and second capillary valve 298, as shown in FIGS. 3h, 3i, and 3j. In the operation of the platform, structures 314, 313, 312, 297 and 298 are present, inter alia, to ensure that the biological material does not foul the distribution manifold 316, and to facilitate fluid flow from the distribution reagent reservoir (which typically has a much larger volume, and corresponding pressure head produced by platform rotation) into the reaction reservoir 306 at an appropriate pressure and velocity. It will be appreciated that the capacity to move fluid comprising the distribution reagent in the direction of the center of rotation (i.e., against the centrifugal force produced by rotation) is dependent upon and a consequence of the greater volume and concomitant pressure under which the distribution reagent flows upon disk rotation.

Upon reaching the reaction reservoir 306, all or a portion of the distribution reagent 321 mixes with the mixed plug 320 to form mixed sample 322 (FIGS. 3k and 3l). It is an advantage of the inventive platforms as disclosed herein that distribution reagent 321 approaches mixed plug 320 from the direction opposite to the centrifugal force, which itself is directed from the center of the disk 299 to the outer periphery of the disk 299. If distribution reagent 321 approached the mixed plug in the same direction as the centrifugal force, it is possible that some portion of the cells 319 would remain packed against the wall of the reaction reservoir 306 and would not mixed with distribution reagent 321. Introducing distribution reagent 321 from the opposite side ensures that the mixed plug 320 is substantially disturbed by distribution reagent 321, resulting in a thoroughly mixed sample 322. When distribution reagent 321 includes a lytic agent such as acetonitrile, cells 319 break into fragments.

Upon further rotation of disk 299 at a third rotational speed f₃, from about 2000 rpm to about 10000 rpm, cells 319, whether fragmentized or not, are pelleted under centrifugal force and form pellet 324 in reaction reservoir 306 at a position in reaction reservoir 306 distal to, most preferably most distal to, the center of rotation (FIG. 3m). The liquid portion of mixed sample 322 forms supernatant 323 cleared of cells 319 and cellular debris thereof. Pellet 324 advantageously blocks blocking channel 305, thereby advantageously preventing supernatant 323 from leaving reaction reservoir 306.

In certain embodiments, supernatant 323 can be optically interrogated to detect drug, drug metabolites, drug products, cytotoxicity or other properties or characteristics of drug metabolism for quantification purposes. In these embodiments, portion 307 of reaction reservoir 306 advantageously comprises an optical detection cuvette. For example, fluorescence or absorbance measurements, or other optical detection methods know to the skilled worker can be made in the provided on the disk, using either microfluidic components or by manually loading said reagents into the reaction reservoir, for use with a reaction that is optically detectable, using for example FRET and molecular beacon assays. Further reagent additions may occur, such as indicator compounds; color-generating or fluorescence-generating compounds that indicate the presence of specific metabolites generated by cultured cells; spectrophotometrically detect metabolites or altered forms of co-factors, and other detection methods known to those with skill in the art.

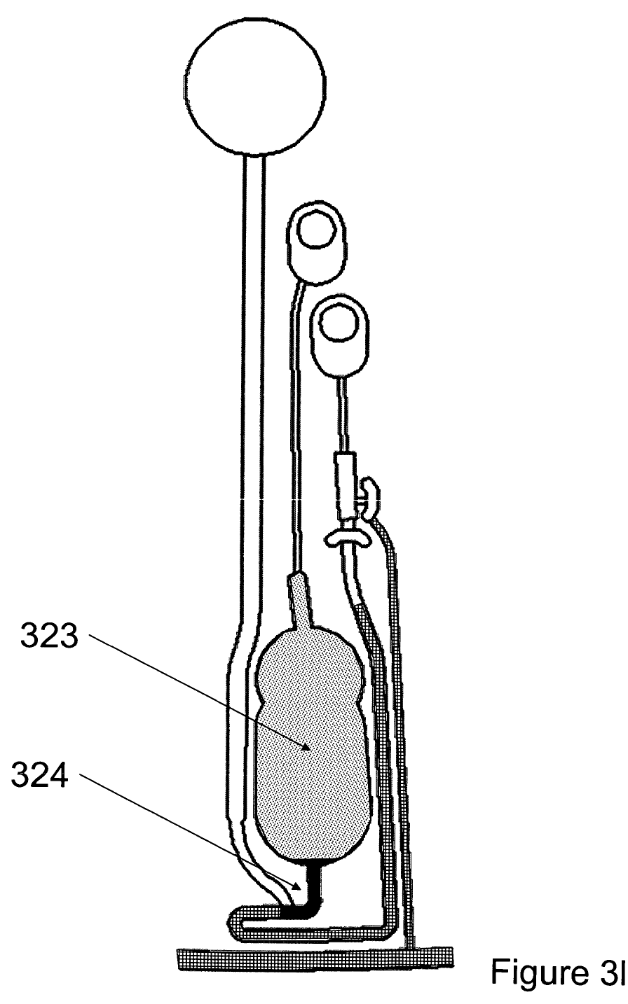

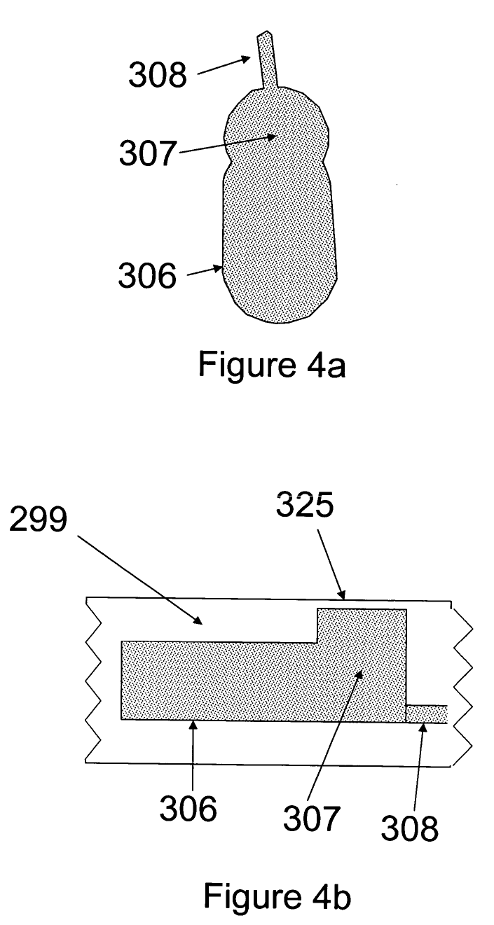

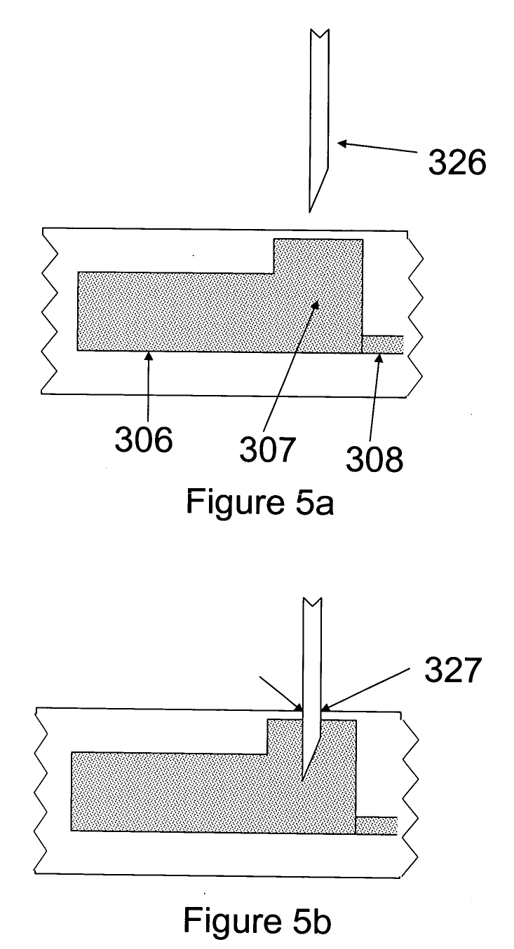

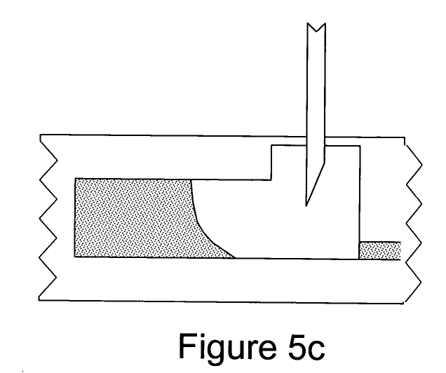

In alternative embodiments, supernatant 323 is extracted from the platform for further analysis using methods such as mass spectrometry or HPLC, which are not easily adapted to performance on the platform. In additional alternative embodiments, supernatant 323 is transferred to a microtiter plate for use in another assay. For use with these embodiments, the microsystems platforms of the invention are provided having a thin pierceable membrane 325 above the portion 307 of reaction chamber 306. Thin membrane 325 is provided to be fragile enough to be pierceable by a piercing means 326, such as a manually-operated pipette tip, an automated pipette tip, a manually-operated needle, an automated needle, or any analogous device. When piercing means 326 is pushed through thin membrane 325, a hole 327 is formed, allowing the piercing means to access supernatant 323. When piercing means 326 is attached to an aspiration means, the supernatant can be aspirated for ultimate dispensing into another device or carrier. Aspiration means include a syringe, a pipette, and other such means. Reaction reservoir 306 adapted to permit extraction of supernatant 323 from the platform is illustrated in FIGS. 4a and 4b and FIGS. 5a through 5c.

The following Examples are intended to further illustrate certain preferred embodiments of the invention and are not limiting in nature.

### EXAMPLE 1

The disk disclosed in FIGS. 1-3 was used in order to illustrate drug metabolism assays as provided herein.

The microsystems platform was prepared as follows. The fluidic layers were manufactured through embossing in both polypropylene and cyclic olefin polymer, according to the disclosure of co-owned International Patent Application US04/011679, filed Apr. 5, 2004 and incorporated by reference herein.

The dimensions of the platform used for these assays were as follows. The overall platform radius was 7.2 cm., and contained 96 iterations of the microfluidics structure show in FIG. 2 In this embodiment, a loading port 301 is provided having a diameter of about 3 mm, a depth of 4 mm and having a volume of about 30 μL and adapted to contain a cell suspension and one or a plurality of liquid samples comprising a drug or drugs to be tested. Feed channel 302 has an interior diameter 0.8 mm, a depth of about 0.8 mm, and a length of 50 mm. Necking 303 reduced the interior dimension and depth of feed channel 302 from 0.8 mm×0.8 mm to about 0.4 mm×0.4 mm. Reverse feed channel 304, serpentine channel 304 herein, had a length of about 12 mm, interior dimension of 0.25 mm and depth of 0.25 mm, and is in fluid communication with blocking channel 305, having a length of 1 mm, an interior dimension of from about 250 microns, and a depth of about 50 microns to about 5 mm, which is fluidly connected to reaction reservoir 306. Reaction reservoir 306 has a total length of about 5.3 mm, a total width of about 2.5 mm, a depth (in the non-circular portion) of about 2.8 mm, and a volume of about 40 μL, and is arranged on the disk so that the fluid connection between the reaction reservoir and blocking channel 305 is at least slightly more proximal to the center of rotation than the junction between serpentine channel 304 and necking 303. Reaction reservoir 306 comprises a circular portion 307 at the end of the reservoir more proximal to the center of rotation having a diameter of about 2.3 mm, a depth of about 4 mm, and a volume of about 20 μL. Portion 307 of reaction reservoir 306 advantageously comprised an exit or extraction port as described above. Reaction reservoir 306, or when present portion 307, was fluidly connected to stopping channel 308, for example, having a length of 1.2 mm, and interior dimension of a 0.4 mm and a depth of about 1 mm. Stopping channel 308 is in fluid communication with an air displacement channel 309 having an interior dimension of 127×127 microns, and in turn, air chamber 310, having an interior dimension of about 1.2 mm×1.8 mm and a depth of about 0.8 mm. Air chamber 310 comprises air vent 311, which is open to the air and which has a diameter of about 0.8 mm and permits displacement of air from the microfluidics structure of this array upon centrifugal force-motivated fluid movement, and prevents air blockage of clued movement on the platform.

The microfluidic structure also includes a distribution manifold channel 316 that has an interior dimension of 127 microns wide and 127 microns deep in fluidic communication with distribution reagent reservoir 350 (not shown). Distribution reagent reservoir 350 is provided with a distribution reagent loading port to permit the agent to be loaded onto the disk prior to loading sample, immediately before delivering the agent through the distribution manifold 316 to reaction reservoir 306, or at any time appropriate to the agent and the assay reaction to be quenched by the agent. Distribution manifold channel 316 carries a common distributed reagent, a distribution reagent, herein acetonitrile, from the distribution reagent reservoir 350 to each of the plurality of reaction reservoirs as set forth herein, and thus has a length dependent on the distance from distribution reagent reservoir 350 and each of the microfluidics structures arrayed on the surface of the disk The distribution reagent 321 is introduced into each individual microfluidic structure by distribution feed channel 315 having a length of 45 mm and an interior dimension of from about 50 microns to about 5 mm that is in fluid communication with an intermediate chamber 312. Intermediate chamber 312 has an interior dimension 0.4 mm wide, 1.5 mm long and 1 mm deep, and a volume of about 1-5 μL, and is in fluid communication with an air displacement channel 309 and, in turn, air chamber 310, which contains an air vent 311 and open to the air, permitting air displacement as described above. vent 311 and open to the air, permitting air displacement as described above. Intermediate chamber 312 and distribution feed channel 315 were fluidly connected by first capillary microvalve 314 and first connector channel 313, wherein first connector channel 313 has a length of from about 5 microns to about 5 mm, an interior dimension of from about 5 microns to about 5 mm and a depth of from about 5 microns to about 5 mm. Intermediate chamber 312 is also in fluid communication with second connector channel 297 having a length of from about 5 microns to about 5 mm, and an interior dimension of from about 5 microns to about 5 mm, that is in fluid communication with second capillary microvalve 298. First and second capillary microvalves 297 and 298 had a depth of from about 1 to 200 microns. Second capillary microvalve 298 is in fluid connection with serpentine channel 304.

A drug metabolism determining assay was performed as follows. A small molecule drug compound, designated “Compound X” herein, was prepared in a 2 μM solution of hepatocyte cell growth medium containing small amounts of acetonitrile and DMSO, each making up less than 2% of the overall liquid volume. Human cryopreserved hepatocytes were suspended in growth medium to a final concentration of 1,000,000 viable cells per mL of liquid. Growth medium or cell culture medium is typically selected to provide good living conditions for the type of cells being used. A disk having 96 independent microfluidic structures was used, wherein half of the 96 structures were connected to one distribution manifold, while the remaining half were connected to a second, independent distribution manifold. A selection of 12 loading ports were loaded with 5 μL of Compound X solution followed by 5 μL of hepatocyte suspension. Loading was performed manually using a pipette, but such loading can also be executed with robotic liquid handlers. The disk was then spun for 20 seconds at a rate of 1500 rpm, whereafter all liquids moved to the reaction reservoirs attached to each loading port. The disk was then placed in a 37° incubator for one hour. After removing the disk from the incubator, another group of 12 loading ports were loaded in the same fashion as the first loading step. The disk was spun again for 20 seconds at 1500 rpm, and the new-loaded liquids moved to the reaction reservoirs attached to their respective loading ports, while the previous-loaded liquids simply stayed in their respective reaction reservoirs. Additional series of loading, spinning, and incubating steps were repeated in this fashion until all 96 microfluidic structures were eventually loaded. This process took a total of 6 hours. At this point, acetonitrile was loaded into each of two distribution reagent loading ports. The disk was spun at 4000 rpm for 5 manifold channel and into all of the individual distribution feed channels. Eventually, each reaction reservoir was completely filled. Of the liquid in each reaction reservoir, 10 μL was the original reactants (solution of Compound X and suspension of cells) and the remainder (approximately 30 μL) was acetonitrile. During this quenching process, the cells are lysed into cell fragments. During the latter stages of the 5-minute spin at 4000 rpm, these cell fragments sedimented towards the outer edge of the reaction reservoir, eventually clogging the blocking channel, thereby blocking each reaction reservoir from all other liquids.

After the distribution step, each of the thin membranes was pierced in turn using a needle. A syringe attached to the needle was used to aspirate approximately 20 μL of supernatant from each reaction reservoir. The needle and syringe were cleaned between aspirations. Each supernatant sample was placed in a unique well of a microtiter plate. After all 96 samples were extracted, they were analyzed using a mass spectrometer. The mass spectrometer was equipped with an autosampler for retrieving liquid samples from the microtiter plate, and was further equipped with a spectrometer method designed to specifically detect the concentration of Compound X.

Once all concentration measurements were made, the data were organized based on the total incubation time of each sample. Multiple measurements from the same incubation time were average, and the results were plotted to provide a curve such as the one shown in FIG. 6. From such a curve, it is possible to calculate a time constant for the time-dependent metabolic clearance of Compound X by human hepatocytes.

It should be understood that the foregoing disclosure emphasizes certain specific embodiments of the invention and that all modifications or alternatives equivalent thereto are within the spirit and scope of the invention.

1. A centripetally-motivated microsystems platform comprising:
a) a rotatable platform comprising a substrate having a surface comprising a one or a multiplicity of microfluidics structures embedded in the surface of the platform, wherein each microfluidics structure comprises
i) a loading port fluidly connected to,
i) a feed channel, fluidly connected to
ii) a reverse feed channel that is fluidly connected to
iii) a reaction reservoir
b) wherein the reaction reservoir is vented to the atmosphere, and further comprising a distribution reagent reservoir fluidly connected to the reverse feed channel
and wherein fluid within the microchannels of the platform is moved through said microchannels by centripetal force arising from rotational motion of the platform for a time and a rotational velocity sufficient to move the fluid through the microchannels.

2. A Microsystems platform according to claim 1, wherein the reaction reservoir is vented to the atmosphere through an air displacement channel and an air vent.

3. A microsystems platform according to claim 1, wherein the distribution reagent reservoir is fluidly connected to the reverse feed channel by a distribution manifold

4. A microsystem platform of claim 3 wherein the distribution reagent reservoir further comprises a bulk loading port and the distribution manifold comprises one or a plurality of microchannels fluidly connected to the reverse feed channel of each of the multiplicity of microfluidics structures of the platform.

5. A microsystem platform of claim 1 further comprising a blocking channel fluidly connected between the reverse feed channel and the reaction reservoir, wherein the blocking channel has an interior dimension smaller than the interior dimension of the reverse feed channel.

6. A microsystem platform of claim 1 wherein the distribution reagent reservoir has a volumetric capacity of from about 100 μL to about 100 mL.

7. A microsystem platform of claim 1 wherein each reaction reservoir has a volumetric capacity of from about 1 μL to about 1 mL.

8. A microsystem platform of claim 1 further comprising
c) an intermediate chamber
d) first and second capillary valves and
e) first and second connector channels,
wherein the first connector channel to fluidly connected to the intermediate chamber by the first capillary valve and the second connector channel is fluidly connected to the intermediate chamber by the second capillary valve, and the first connector channel us fluidly connected to the distribution manifold and the second connector channel is fluidly connected to the reverse feed channel.

9. A microsystem platform of claim 8 wherein the intermediate chamber is vented to the atmosphere through an air displacement channel and an air vent.

10. A microsystem platform of claims 1 or 8 that is a circular disk having a radius of about 1 cm to about 25 cm

11. The microsystem platform of claims 1 or 8, wherein the microsystem platform is constructed of a material selected from the group consisting of an organic material, an inorganic material, a crystalline material and an amorphous material.

12. The microsystem platform of claim 11, wherein the microsystem platform further comprises a material selected from the group consisting of silicon, silica, quartz, a ceramic, a metal or a plastic.

13. The microsystem platform of claims 1 or 8, wherein the microsystem platform has a thickness of about 0.1 mm to 100 mm, and wherein the cross-sectional dimension of the microchannels embedded therein is less than 1 mm and from 1 to 90 percent of said cross-sectional dimension of the platform.

14. The microsystem platform of claims 1 or 8, wherein the microsystem platform comprising from 24 to 10,000 microfluidics structures.

15. The Microsystems platform of claims 1 or 8, wherein the reaction reservoir comprises a portion adapted for measuring a component of a fluid mixture contained in the reservoir.

16. A microsystems platform according to claim 15, wherein the portion of the reaction reservoir is an optical detection cuvette having a surface that can be interrogated to detect a component of the fluid mixture in the reservoir.

17. A Microsystems platform according to claim 15, wherein the reaction reservoir is interrogated by absorbance spectroscopy, fluorescence spectroscopy, or chemiluminescence.

18. A microsystem platform of claim 17 wherein a portion of the reaction reservoirs is optically transparent.

19. The microsystems platform of claims 1 or 8, wherein the reaction reservoir comprises a portion adapted for extracting all or a portion of a fluid mixture contained in the reservoir.

20. The Microsystems platform of claims 1 or 8, wherein a portion of the reaction reservoir is adapted for extracting all or a portion of a fluid mixture contained in the reservoir by having a pierceable surface.

21. The microsystem platform of claim 20 wherein the pierceable surface can be pierced by a micropipettor tip or a syringe needle.

22. A centripetally-motivated fluid micromanipulation apparatus that is a combination of
a microsystem platform according to claims 1 or 8, and
a micromanipulation device, comprising a base, a rotating means, a power supply and operations controlling means, wherein the rotating means is operatively linked to the microsystem platform and in rotational contact therewith
wherein a volume of a fluid within the microchannels of the platform is moved through said microchannels by centripetal force arising from rotational motion of the platform for a time and a rotational velocity sufficient to move the fluid through the microchannels.

23. The apparatus of claim 22, wherein the rotating means of the device is a motor.

24. The apparatus of claim 22, wherein the device comprises a rotational motion controlling means for controlling the rotational acceleration and velocity of the microsystem platform.

25. An apparatus of claim 22 wherein the micromanipulation apparatus further comprises an optical detector that measures absorbance, fluorescence, or chemoluminescence.

26. An apparatus of claim 22 wherein the micromanipulation apparatus further comprises a radiometric detector or a scintillation detector.

27. An apparatus of claim 25, wherein the detector is brought into alignment with the collection chamber on the platform by rotational motion of the microsystem platform.

28. The apparatus of claim 27, wherein the detector is an optical detector comprising a light source and a photodetector.

29. A method for performing a cell-based assay, comprising the steps of:
a) applying a volume of one or a plurality of fluids comprising a test compound to a loading port of a microfluidics array of the Microsystems platform according to claim 1 when the platform is stationary;
b) applying a volume of a fluid comprising a cell suspension to the loading port of a microfluidics array of the Microsystems platform according to claims 1 or 8 when the platform is stationary,
c) rotating the platform at a first rotational speed for a time and at a speed wherein the volume of one or plurality of fluids comprising a test compound and the volume of the cell suspension traverses the longitudinal extent of the feed channel and wherein the volume of one or plurality of fluids comprising a test compound and the volume of the cell suspension are mixed to form a mixed volume, and wherein the mixed volume is motivated by rotation of the platform through the reverse feed channel and into the reaction reservoir,
d) incubating the platform for a time and under conditions for a cell-based assay to occur in the reaction reservoir;
e) rotating the platform at a second rotational speed that can be the same or higher than the first rotational speed wherein a volume of a distribution reagent is motivated by rotation of the platform through the distribution manifold and into the reaction reservoir; and
f) rotating the platform at a third rotational speed that is higher than the second rotational speed to pellet cells or fragments thereof onto a surface of the reaction reservoir distal to the center of rotation; and;
g) detecting a product of the cell based assay.

30. A method according to claim 29, wherein the reagent is a drug or drug lead compound.

31. A method according to claim 30, wherein the cell suspension comprises hepatocytes.

32. A method according to claim 30, wherein the distribution reagent is acetonitrile.

33. A method for performing a cell-based assay, comprising the steps of:
a) applying a volume of one or a plurality of fluids comprising a test compound to a loading port of a microfluidics array of the Microsystems platform according to claim 8 when the platform is stationary;
b) applying a volume of a fluid comprising a cell suspension to the loading port of a microfluidics array of the Microsystems platform according to claims 1 or 8 when the platform is stationary,
c) rotating the platform at a first rotational speed for a time and at a speed wherein the volume of one or plurality of fluids comprising a test compound and the volume of the cell suspension traverses the longitudinal extent of the feed channel and wherein the volume of one or plurality of fluids comprising a test compound and the volume of the cell suspension are mixed to form a mixed volume, and wherein the mixed volume is motivated by rotation of the platform through the reverse feed channel and into the reaction reservoir,
d) incubating the platform for a time and under conditions for a cell-based assay to occur in the reaction reservoir;
e) rotating the platform at a second rotational speed that can be the same or higher than the first rotational speed wherein a volume of a distribution reagent is motivated by rotation of the platform through the distribution manifold, the intermediate chamber and the reverse flow channel and into the reaction reservoir; and
f) rotating the platform at a third rotational speed that is higher than the second rotational speed to pellet cells or fragments thereof onto a surface of the reaction reservoir distal to the center of rotation; and
g) detecting a product of the cell based assay.

34. A method according to claim 33, wherein the reagent is a drug or drug lead compound.

35. A method according to claim 34, wherein the cell suspension comprises hepatocytes.

36. A method according to claim 34, wherein the distribution reagent is acetonitrile.

37. A method according to claims 29 or 33 wherein the product of the cell based assay is detected by absorbance spectroscopy, fluorescence spectroscopy, or chemiluminescence.

38. A method according to claims 29 or 33 wherein the product of the cell based assay is detected by radiometric or scintillation methods

39. A method according to claims 29 or 33 wherein the cell-based assay is a drug metabolism assay.
